(19) United States
(12) Patent Application Publication
(10) Pub. No.: US 2020/0377127 A1
(43) Pub. Date: Dec. 3, 2020

(54) VEHICLE CONTROL SYSTEM AND VEHICLE CONTROL INTERFACE

(71) Applicant: TOYOTA JIDOSHA KABUSHIKI KAISHA, Toyota-shi (JP)

(72) Inventor: Eisuke ANDO, Nagoya-shi (JP)

(73) Assignee: TOYOTA JIDOSHA KABUSHIKI KAISHA, Toyota-shi (JP)

(21) Appl. No.: 16/833,915

(22) Filed: Mar. 30, 2020

(30) Foreign Application Priority Data
May 28, 2019 (JP) 2019-099648

(51) Int. Cl. B60W 60/00; B60W 50/02

(52) U.S. Cl. CPC B60W 60/00188; B60R 25/01; B60W 2520/06; B60W 50/0205

(57) ABSTRACT

A vehicle control system includes a vehicle platform including a first computer configured to perform traveling control of a vehicle and an autonomous driving platform including a second computer configured to perform autonomous driving control of the vehicle. The second computer generates control instruction information with respect to the vehicle platform and the first computer performs the traveling control of the vehicle based on the control instruction information. The vehicle control system further includes a vehicle control interface configured to relay the control instruction information. The vehicle control interface prohibits the second computer from performing the autonomous driving control of the vehicle in a case where predetermined authentication information indicating that the autonomous driving platform is genuine is not received from the autonomous driving platform.

### INCORPORATION BY REFERENCE

The disclosure of Japanese Patent Application No. 2019-099648 filed on May 28, 2019 including the specification, drawings and abstract is incorporated herein by reference in its entirety.

### BACKGROUND

### 1. Technical Field

The disclosure relates to a vehicle control system for a vehicle that is autonomously driven.

### 2. Description of Related Art

Described in Japanese Unexamined Patent Application Publication No. 2018-132015 (JP 2018-132015 A) is a vehicle system in which an autonomous driving ECU having a function of sensing the vicinity of a vehicle is provided in the vehicle separately from an engine ECU and the autonomous driving ECU issues a command to the engine ECU via a vehicle-mounted network.

### SUMMARY

The disclosure provides a technique with which it is possible to improve vehicle control security for a vehicle that is autonomously driven.

An aspect of the disclosure relates to a vehicle control system including a vehicle platform including a first computer configured to perform traveling control of a vehicle and an autonomous driving platform including a second computer configured to perform autonomous driving control of the vehicle. The second computer generates first control instruction information with respect to the vehicle platform. The first computer performs the traveling control of the vehicle based on the first control instruction information. The vehicle control system further includes a vehicle control interface configured to receive the first control instruction information from the autonomous driving platform and configured to transmit the first control instruction information to the vehicle platform. The vehicle control interface includes a controller configured to prohibit the second computer from performing the autonomous driving control of the vehicle in a case where predetermined authentication information indicating that the autonomous driving platform is genuine is not received from the autonomous driving platform.

According to the aspect of the disclosure, it is possible to improve vehicle control security for a vehicle that is autonomously driven.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a vehicle control system according to an embodiment;

FIG. 2 is a block diagram schematically illustrating an example of the configuration of the vehicle control system;

FIG. 3 is a diagram for describing input and output data in a controller of a vehicle control interface; and

FIG. 4 is a flowchart of an authentication information determination process in the embodiment.

### DETAILED DESCRIPTION OF EMBODIMENTS

In a vehicle control system according to an aspect of the disclosure, a vehicle platform including a first computer that performs traveling control of a vehicle and an autonomous driving platform including a second computer that performs autonomous driving control of the vehicle are configured independently of each other. The second computer in the autonomous driving platform generates first control instruction information with respect to the vehicle platform. The first control instruction information includes information for instructing the vehicle on the degree of acceleration and deceleration and the angle of steered wheels and for performing traveling control of the vehicle. In addition, the first computer in the vehicle platform performs traveling control of the vehicle based on the first control instruction information generated by the second computer. In this manner, the vehicle control system according to the aspect of the disclosure includes a platform (autonomous driving platform) that generates the first control instruction information for the autonomous driving control, separately from the vehicle platform.

With the above-described configuration, in the case of the vehicle control system according to the aspect of the disclosure, it is possible to install an autonomous driving platform developed by a maker or a vendor different from a maker or a vendor of a vehicle platform. At this time, there is a possibility that an autonomous driving platform (non-genuine autonomous driving platform) not permitted to be installed in the vehicle control system is installed in the vehicle control system. In terms of vehicle control security, it is not preferable that the vehicle is autonomously driven in a state where a non-genuine autonomous driving platform is installed therein.

Therefore, the vehicle control system according to the aspect of the disclosure is provided with a vehicle control interface that receives the first control instruction information from the autonomous driving platform and transmits the first control instruction information to the vehicle platform. In addition, the vehicle control interface includes a controller that prohibits the second computer from performing the autonomous driving control of the vehicle in a case where predetermined authentication information indicating that the autonomous driving platform is genuine is not received from the autonomous driving platform.

Here, the expression “the autonomous driving platform is genuine” means that the autonomous driving platform is an autonomous driving platform permitted to be installed in the vehicle control system including the vehicle platform. In addition, the “authentication information” is information used to determine whether or not the autonomous driving platform is genuine. For example, the predetermined authentication information (hereinafter, may be referred to as “genuine authentication information”) indicating that the autonomous driving platform is genuine may be determined in advance between a maker or a vendor of the vehicle platform and a maker or a vendor of the autonomous driving platform.

In a case where a non-genuine autonomous driving platform is installed in the vehicle control system, even if authentication information is transmitted from the non-genuine autonomous driving platform, the authentication information is not genuine authentication information. In this case, the vehicle control interface receives no genuine authentication information from the autonomous driving platform. In addition, in a case where the non-genuine autonomous driving platform transmits no authentication information to the vehicle control interface as well, the vehicle control interface receives no genuine authentication information from the autonomous driving platform. As described above, in a case where the autonomous driving platform is not genuine, the vehicle control interface receives no genuine authentication information. Therefore, in a case where the vehicle control interface receives no genuine authentication information from the autonomous driving platform, a determination can be made that the autonomous driving platform is not genuine.

In addition, the controller in the vehicle control interface prohibits the second computer from performing the autonomous driving control of the vehicle in a case where the predetermined authentication information is not received from the autonomous driving platform. Accordingly, the first computer of the vehicle platform is prohibited from performing the traveling control of the vehicle based on the first control instruction information generated by the non-genuine autonomous driving platform. In other words, it is possible to suppress autonomous driving of the vehicle performed in a state where the non-genuine autonomous driving platform is installed in the vehicle. Accordingly, it is possible to improve vehicle control security for a vehicle that is autonomously driven.

In addition, the controller in the vehicle control interface may prohibit the first control instruction information received from the autonomous driving platform from being transmitted to the vehicle platform in a case where the predetermined authentication information is not received from the autonomous driving platform. Accordingly, it is possible to prohibit the second computer from performing the autonomous driving control of the vehicle in a case where the predetermined authentication information is not received from the autonomous driving platform.

Hereinafter, a specific embodiment of the disclosure will be described based on drawings. The dimensions, the materials, the shapes, and the relative arrangement of components described in the present embodiment are not intended to limit the technical scope of the disclosure unless otherwise noted.

### Embodiment

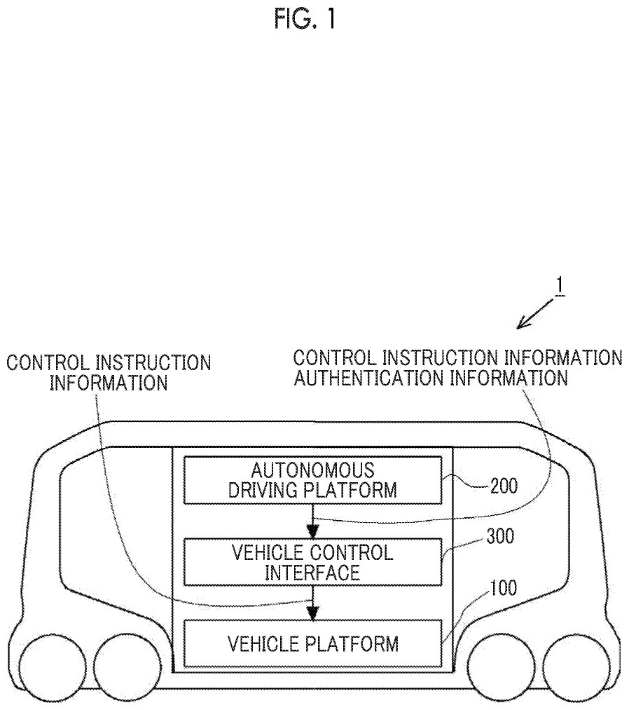

The outline of a vehicle control system 1 according to an embodiment will be described. As shown in FIG. 1, the vehicle control system 1 according to the present embodiment is configured to include a vehicle platform 100, an autonomous driving platform 200, and a vehicle control interface 300. The vehicle platform 100 is a vehicle platform in the related art. The vehicle platform 100 is operated based on control instruction information. The control instruction information is encapsulated by means of CAN frames flowing in a vehicle-mounted network, for example.

The autonomous driving platform 200 includes means for sensing the vicinity of a vehicle. Accordingly, the autonomous driving platform 200 can generate control instruction information with respect to the vehicle platform 100 based on the result of a sensing operation. The control instruction information is information for traveling control of the vehicle. The control instruction information may be information for instructing the vehicle on the degree of acceleration and deceleration and the angle of steered wheels, for example. The vehicle platform 100 performs the traveling control of the vehicle based on the control instruction information generated in the autonomous driving platform 200. In addition, the vehicle platform 100 also can perform the traveling control based on control instruction information generated due to an operation performed by an occupant. Note that, “first control instruction information” according to the aspect of the disclosure corresponds to the control instruction information generated in the autonomous driving platform. In addition, “second control instruction information” according to the aspect of the disclosure corresponds to the control instruction information generated due to the operation performed by the occupant.

The vehicle control interface 300 receives the control instruction information generated in the autonomous driving platform 200. Then, the vehicle control interface 300 transmits, to the vehicle platform 100, the control instruction information received from the autonomous driving platform 200.

Here, in the vehicle control system 1 according to the present embodiment, when the autonomous driving platform 200 is genuine, the vehicle control interface 300 receives control instruction information, to which genuine authentication information has been added, from the autonomous driving platform 200. Here, the autonomous driving platform 200 being genuine means that the autonomous driving platform 200 is permitted to be installed in the vehicle control system 1 including the vehicle platform 100. In other words, the autonomous driving platform 200 being not genuine (that is, autonomous driving platform 200 being non-genuine autonomous driving platform) means that the autonomous driving platform 200 is not permitted to be installed in the vehicle control system 1 including the vehicle platform 100. In addition, the genuine authentication information is authentication information indicating that the autonomous driving platform 200 is genuine. For example, as the genuine authentication information, a text string indicating that the autonomous driving platform 200 is genuine may be determined in advance between the vehicle control interface 300 and the autonomous driving platform 200.

Meanwhile, in the vehicle control system 1 according to the present embodiment, when the autonomous driving platform 200 is not genuine, the vehicle control interface 300 does not receive the control instruction information, to which the genuine authentication information has been added, from the autonomous driving platform 200. Here, examples of a case where the control instruction information to which the genuine authentication information has been added is not received include a case where no authentication information has been added to control instruction information received from the autonomous driving platform 200. In addition, there is also a case where authentication information has been added to the control instruction information received from the autonomous driving platform 200 but the authentication information is not genuine authentication information. As described above, when the autonomous driving platform 200 is not genuine, the vehicle control interface 300 cannot receive the genuine authentication information. Therefore, when the vehicle control interface 300 receives no genuine authentication information from the autonomous driving platform 200, a determination can be made that the autonomous driving platform 200 is not genuine.

As described above, the vehicle control interface 300 can determine whether or not the autonomous driving platform 200 is genuine by determining whether or not control instruction information, to which authentication information has been added, has been received from the autonomous driving platform 200 and whether or not the authentication information added to the control instruction information received from the autonomous driving platform 200 is genuine authentication information.

In addition, when the control instruction information to which the genuine authentication information has been added is received from the autonomous driving platform 200, the vehicle control interface 300 transmits, to the vehicle platform 100, the control instruction information received from the autonomous driving platform 200. Meanwhile, when there is no genuine authentication information added to the control instruction information received from the autonomous driving platform 200, that is, when the control instruction information to which the genuine authentication information has been added is not received from the autonomous driving platform 200, the vehicle control interface 300 prohibits the control instruction information received from the autonomous driving platform 200 from being transmitted to the vehicle platform 100. In this case, the control instruction information received from the autonomous driving platform 200 is not transmitted from the vehicle control interface 300 to the vehicle platform 100.

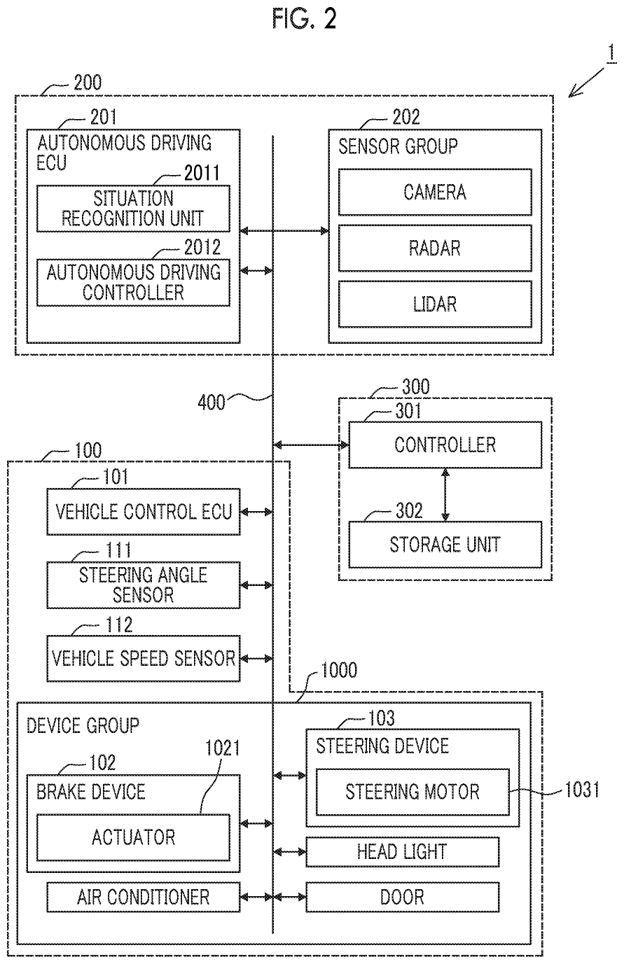

Next, constituent elements of the system will be described in detail. FIG. 2 is a block diagram schematically illustrating an example of the configuration of the vehicle control system 1 shown in FIG. 1. The vehicle control system 1 includes the vehicle platform 100, the autonomous driving platform 200, and the vehicle control interface 300 and each constituent element is communicatably connected by means of a bus 400. Here, in communication between the vehicle platform 100 and the vehicle control interface 300 and communication between the autonomous driving platform 200 and the vehicle control interface 300, a message authentication code (MAC) may be used. At this time, an MAC different from an MAC used for external communication between the vehicle control system 1 and an external device may be used such that different security zones are formed for external communication and in-vehicle communication.

The vehicle platform 100 is configured to include a vehicle control ECU 101, a device group 1000 including a brake device 102 and a steering device 103, a steering angle sensor 111, and a vehicle speed sensor 112. Note that, although a vehicle with an engine is used as an example in the present example, a target vehicle may be an electric vehicle. In this case, an engine ECU can be substituted with an ECU managing the power of the vehicle. Note that, in the vehicle platform 100, an ECU or a sensor other than those illustrated may be provided.

The vehicle control ECU 101 is a computer that controls constituent elements (for example, engine system component, powertrain system component, brake system component, electric system component, body system component, or like) of the vehicle. The vehicle control ECU 101 may be a combination of a plurality of computers. The vehicle control ECU 101 controls the rotation rate of an engine by performing fuel injection control, for example. The vehicle control ECU 101 can control the rotation rate of the engine based on control instruction information (for example, information about instruction designating throttle valve opening degree) generated due to an operation (operation on accelerator pedal or like) performed by an occupant, for example.

In addition, in a case where the vehicle is an electric vehicle, the vehicle control ECU 101 can control the rotation rate of a motor by controlling a drive voltage, a drive current, a drive frequency, or the like. In this case as well, as with an internal combustion vehicle, it is possible to control the rotation rate of the motor based on control instruction information generated due to an operation performed by the occupant. In addition, it is possible to control a regenerative current based on control instruction information indicating a depressing force on a brake pedal or the degree of regenerative braking. Note that, in a case where the vehicle is a hybrid vehicle, both of control with respect to an engine and control with respect to a motor may be performed.

In addition, the vehicle control ECU 101 can control a braking force of a mechanical brake by controlling an actuator 1021 included in the brake device 102. The vehicle control ECU 101 controls brake hydraulic pressure by driving the actuator 1021 based on control instruction information (for example, information about instruction indicating depressing force on brake pedal) generated due to an operation (operation on brake pedal or like) performed by the occupant.

In addition, the vehicle control ECU 101 can control a steering angle or the angle of steered wheels (steering angle) by controlling a steering motor 1031 included in the steering device 103, which will be described later. The vehicle control ECU 101 controls the steering angle of the vehicle by driving the steering motor 1031 based on control instruction information (for example, information about instruction indicating steering angle) generated due to an operation (steering operation or like) performed by the occupant.

Note that, as described above, control instruction information may be generated in the vehicle platform 100 based on an operation performed by the occupant and may be generated by the autonomous driving platform 200. That is, the vehicle control ECU 101 can perform traveling control of the vehicle based on control instruction information (second control instruction information) generated due to an operation performed by the occupant and control instruction information (first control instruction information) generated by the autonomous driving platform 200.

The device group 1000 is a plurality of devices that the vehicle includes and is devices controlled by the vehicle control ECU 101. Typically, the device group 1000 is configured to include the brake device 102, the steering device 103, an air conditioner, a head light, a door, and the like. The device group 1000 may include a locking and unlocking device for a door or a trunk, a wiper, an in-vehicle-cabin light, a direction indicator, a hazard lamp, a parking brake, a shifting device, and the like.

The brake device 102 is a mechanical brake system that the vehicle includes. The brake device 102 is configured to include an interface (brake pedal or like), the actuator 1021, a hydraulic pressure system, a brake cylinder, and the like. The actuator 1021 is means for controlling the hydraulic pressure in the brake system. With the actuator 1021, which receives an instruction from the vehicle control ECU 101, controlling the brake hydraulic pressure, it is possible to secure a braking force of a mechanical brake.

The steering device 103 is a steering system that the vehicle includes. The steering device 103 is configured to include an interface (steering wheel or like), the steering motor 1031, a gear box, a steering column, and the like. The steering motor 1031 is means for assisting a steering operation. With the steering motor 1031, which receives an instruction from the vehicle control ECU 101, being driven a force needed for the steering operation can be reduced. In addition, it is also possible to achieve automation of the steering operation, which does not depend on an operation performed by the occupant, by driving the steering motor 1031.

The steering angle sensor 111 is a sensor that measures a steering angle obtained through a steering operation. A measured value obtained by the steering angle sensor 111 is transmitted to the vehicle control ECU 101 as needed. Although a value that directly indicates the turning angle of tires is used as the steering angle in the present embodiment, a value that indirectly indicates the turning angle of tires may also be used as the steering angle. The vehicle speed sensor 112 is a sensor that measures the speed of the vehicle. A measured value obtained by the vehicle speed sensor 112 is transmitted to the vehicle control ECU 101 as needed.

Next, the autonomous driving platform 200 will be described. The autonomous driving platform 200 is a device that senses the vicinity of the vehicle, generates a plan about a traveling operation based on the result of a sensing operation, and generates control instruction information. The autonomous driving platform 200 may be developed by a maker or a vendor different from that of the vehicle platform 100. The autonomous driving platform 200 is configured to include an autonomous driving ECU 201 and a sensor group 202.

The autonomous driving ECU 201 is a computer that performs determination about autonomous driving based on data acquired from the sensor group 202, which will be described later, and communicates with the vehicle platform 100 to control the vehicle. The autonomous driving ECU 201 is configured by using, for example, a central processing unit (CPU). The autonomous driving ECU 201 is configured to include two functional modules, which are a situation recognition unit 2011 and an autonomous driving controller 2012. Each functional module may be realized with a CPU executing a program stored in storage means such as a read only memory (ROM).

The situation recognition unit 2011 detects a surrounding environment around the vehicle based on data acquired by a sensor included in the sensor group 202, which will be described later. Examples of a target to be detected include the number of lanes or the positions of lanes, the number of vehicles present in the vicinity of a host vehicle or the positions of the other vehicles, the number of obstacles (for example, pedestrian, bicycle, structure, and building) present in the vicinity of the host vehicle or the positions of the obstacles, the structure of a road, and a traffic sign. However, the target to be detected is not limited thereto. The target to be detected may be any type of target that needs to be detected for autonomous travel. Data about the environment detected by the situation recognition unit 2011 (hereinafter, referred to as environment data) is transmitted to the autonomous driving controller 2012, which will be described later.

The autonomous driving controller 2012 uses the environment data detected by the situation recognition unit 2011 to control traveling of the host vehicle. For example, the autonomous driving controller 2012 generates a traveling trajectory of the host vehicle based on the environment data, determines the degree of acceleration and deceleration and the steering angle of the vehicle such that the vehicle travels along the traveling trajectory, and generates control instruction information. The control instruction information generated by the autonomous driving controller 2012 is transmitted to the vehicle platform 100 (vehicle control ECU 101) by the autonomous driving platform 200, via the vehicle control interface 300 which will be described later. In addition, as a method of causing the vehicle to autonomously travel, a known method can be adopted.

In addition, in the present embodiment, in a case where the autonomous driving platform 200 is genuine, genuine authentication information is added to the control instruction information generated by the autonomous driving controller 2012 when the control instruction information is transmitted to the vehicle control interface 300.

The autonomous driving controller 2012 generates data designating the degree of acceleration and deceleration and data designating a steering angle and transmits the data to the vehicle control interface 300, as the control instruction information. The data designating the degree of acceleration and deceleration is data designating the amount of (positive or negative) change in vehicle speed per unit time. The data designating the steering angle is data designating the turning angle of steered wheels that the vehicle includes. Although the data is typically the turning angle of tires that are steered wheels, the data may be other than the turning angle as long as the data relates to the steering of the vehicle. For example, the data may be data indicating the angle of a steering wheel, a percentage with respect to the maximum turning angle, or the like. In addition, the data may be a scheduled trajectory of the vehicle.

The sensor group 202 is means for sensing the vicinity of the vehicle, and is typically configured to include a monocular camera, a stereo camera, a radar, a LIDAR, a laser scanner, and the like. The sensor group 202 may include means (GPS module or like) for acquiring the current position of the vehicle in addition to means for sensing the vicinity of the vehicle. Information acquired by a sensor included in the sensor group 202 is transmitted to the autonomous driving ECU 201 (situation recognition unit 2011) as needed.

The autonomous driving platform 200 and the vehicle platform 100 in the vehicle control system 1 are configured independently of each other. Accordingly, an autonomous driving platform different from the autonomous driving platform 200 included in the vehicle control system 1 can be installed in the vehicle control system 1 as a new autonomous driving platform 200. In addition, a program that is to be used for the autonomous driving controller 2012 to generate the control instruction information can be rewritten. The rewriting of such a program enables the autonomous driving controller 2012 to generate control instruction information by using programs that are developed by various makers or vendors and are to be used for the autonomous driving controller 2012 to generate control instruction information with use of devices included in the autonomous driving ECU 201 or the sensor group 202 without a change. As described above, since the autonomous driving platform 200 and the vehicle platform 100 are configured independently of each other, the autonomous driving platform in the vehicle control system 1 can be changed. In addition, since it is possible to change the autonomous driving platform, it is possible to use autonomous driving platforms developed by various makers or vendors for the vehicle control system 1. Note that, “a time when the autonomous driving platform is changed” in the aspect of the disclosure corresponds to a time when “a new autonomous driving platform different from the autonomous driving platform 200 included in the vehicle control system 1 is installed in the vehicle control system 1 as the autonomous driving platform 200” or a time when “the program that is to be used for the autonomous driving ECU 201 to generate control instruction information is rewritten” in the present embodiment.

Next, the vehicle control interface 300 will be described. As described above, in the vehicle control system 1, the autonomous driving platform 200 can be changed. However, in this case, there is a possibility that the autonomous driving platform 200 that is not genuine and originally not permitted to be installed in the vehicle control system 1 is installed in the vehicle control system 1. In terms of vehicle control security, it is not preferable that the vehicle is autonomously driven in a state where the autonomous driving platform 200 that is not genuine is installed therein.

Therefore, in the present embodiment, the vehicle control interface 300 is used as a device that relays control instruction information transmitted from the autonomous driving platform 200 to the vehicle platform 100 and prohibits the control instruction information from being transmitted to the vehicle platform 100 in a case where the autonomous driving platform 200 is not genuine. Note that, each of the vehicle platform 100 and the vehicle control interface 300 may be a single device. In addition, the vehicle control interface 300 may convert control instruction information generated by the autonomous driving platform 200 into control instruction information that can be interpreted by the vehicle control ECU 101 in the vehicle platform 100.

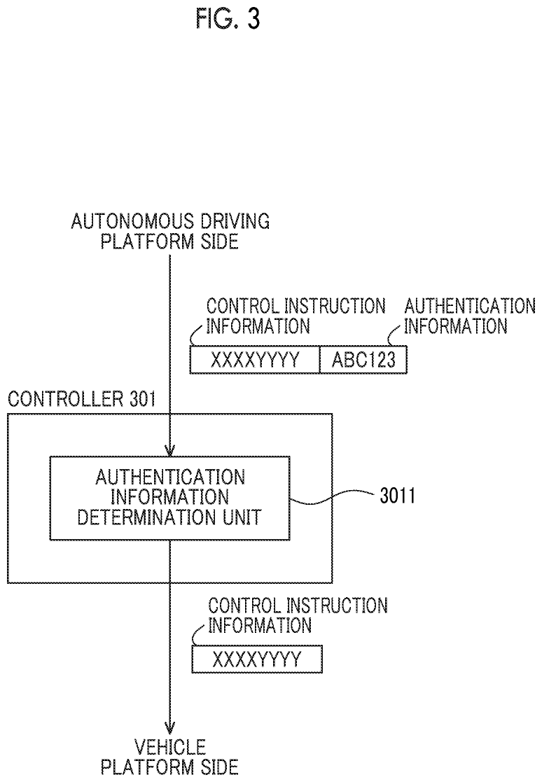

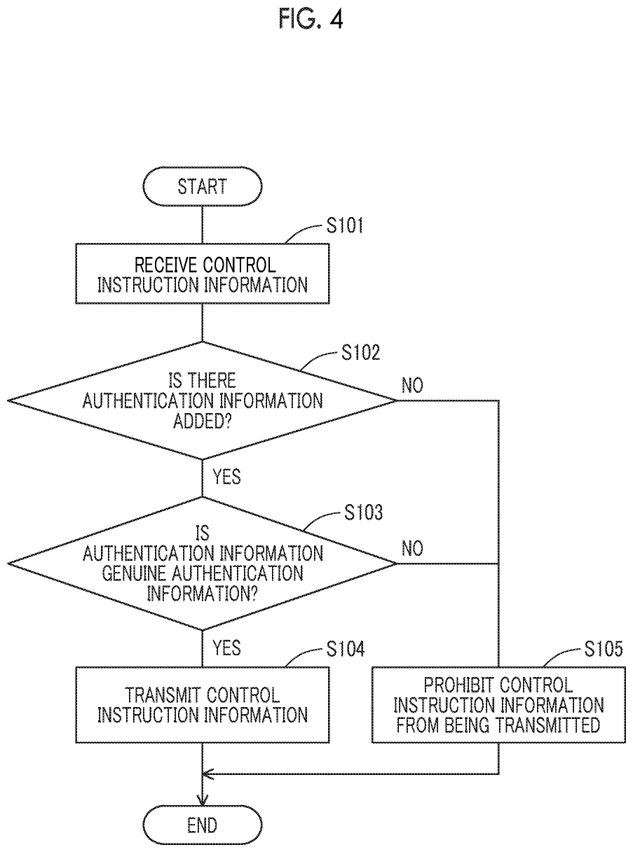

A controller 301 is a controller that processes control instruction information that the vehicle control interface 300 receives from the autonomous driving platform 200. The controller 301 is configured by using, for example, a central processing unit (CPU). Hereinafter, the functions of the controller 301 will be described based on FIGS. 3 and 4. FIG. 3 is a diagram for describing input and output data in the controller 301. As shown in FIG. 3, the controller 301 is configured to include an authentication information determination unit 3011, as a functional module.

In a case where the autonomous driving platform 200 is genuine, control instruction information to which genuine authentication information has been added and that is received from the autonomous driving platform 200 is input to the authentication information determination unit 3011. Then, when the control instruction information to which the genuine authentication information has been added is input to the authentication information determination unit 3011, the authentication information determination unit 3011 outputs the control instruction information to the vehicle platform 100. Accordingly, in a case where the autonomous driving platform 200 is genuine, the controller 301 in the vehicle control interface 300 transmits, to the vehicle platform 100, the control instruction information received from the autonomous driving platform 200. Note that, here, no authentication information is added to the control instruction information transmitted to the vehicle platform 100.

In addition, in a case where the autonomous driving platform 200 is not genuine, the control instruction information to which the genuine authentication information has been added and is not input to the authentication information determination unit 3011 from the autonomous driving platform 200. That is, control instruction information to which no authentication information has been added is input or control instruction information to which authentication information that is not genuine authentication information has been added is input. At this time, the authentication information determination unit 3011 prohibits the control instruction information from being output to the vehicle platform 100. Accordingly, in a case where the autonomous driving platform 200 is not genuine, the controller 301 is prohibited from transmitting, to the vehicle platform 100, the control instruction information received from the autonomous driving platform 200.

In addition, the authentication information determination unit 3011 may be realized with a CPU executing a program stored in a storage unit 302. Here, the storage unit 302 is means for storing information and is configured by using a storage medium such as a RAM, a magnetic disk, and a flash memory. In addition, information about authentication information is stored in the storage unit 302.

Here, an authentication information determination process that is performed by the authentication information determination unit 3011 of the controller 301 will be described with reference to FIG. 4. FIG. 4 is a flowchart showing the flow of the authentication information determination process according to the present embodiment. The authentication information determination process is realized when a predetermined program is executed in the authentication information determination unit 3011 in the vehicle control interface 300. First, control instruction information that the vehicle control interface 300 receives from the autonomous driving platform 200 is input to the authentication information determination unit 3011 (S101).

Next, the authentication information determination unit 3011 determines whether or not there is authentication information added to the control instruction information (S102). In a case where the result of the determination in step S102 is negative, it is possible to determine that the autonomous driving platform 200 is not genuine. Accordingly, the authentication information determination unit 3011 performs a process of prohibiting the control instruction information received from the autonomous driving platform 200 from being transmitted to the vehicle platform 100 (S105). Meanwhile, in a case where the result of the determination in step S102 is positive, the authentication information determination unit 3011 proceeds to processing in S103.

Next, in S103, the authentication information determination unit 3011 performs a process of determining whether or not the authentication information added to the control instruction information is genuine authentication information. In a case where the result of the determination in step S103 is positive, it is possible to determine that the autonomous driving platform 200 is genuine. Therefore, a process of transmitting, to the vehicle platform 100, the control instruction information received from the autonomous driving platform 200 is performed (S104). In addition, in a case where the result of the determination in step S103 is negative, it is possible to determine that the autonomous driving platform is not genuine. Therefore, similarly to a case where the result of the determination in S102 is negative, the authentication information determination unit 3011 performs a process of prohibiting the control instruction information received from the autonomous driving platform 200 from being transmitted to the vehicle platform 100 (S105).

Note that, in the present embodiment, the vehicle control interface 300 performs the authentication information determination process with respect to all of control instruction information received from the autonomous driving platform 200. However, the vehicle control interface 300 may perform the authentication information determination process with respect to a part of control instruction information received from the autonomous driving platform 200. For example, the vehicle control interface 300 may perform the authentication information determination process each time control instruction information is received from the autonomous driving platform 200 a predetermined plurality of times.

In addition, the vehicle control interface 300 may perform the authentication information determination process with respect to control instruction information that is received from the autonomous driving platform 200 while the vehicle is not moving or when the vehicle starts to move instead of while the vehicle is traveling.

At this time, in a case where the autonomous driving platform 200 is not genuine, transmission of control instruction information from the autonomous driving platform 200 to the vehicle platform 100 is prohibited while the vehicle is not moving or when the vehicle starts to move instead of while the vehicle is traveling. Therefore, it is possible to restrain prohibition of transmission of control instruction information from the autonomous driving platform 200 to the vehicle platform 100 from being made while the vehicle is traveling.

In the present embodiment, the authentication information determination unit 3011 of the controller 301 performs the authentication information determination process with respect to control instruction information received from the autonomous driving platform 200. In addition, in a case where there is no authentication information added to the control instruction information received from the autonomous driving platform 200 or in a case where authentication information added to the control instruction information received from the autonomous driving platform 200 is not genuine authentication information, the control instruction information that the vehicle control interface 300 receives from the autonomous driving platform 200 that is not genuine is prohibited from being transmitted to the vehicle platform 100. Therefore, it is possible to restrain the vehicle platform 100 from receiving the control instruction information generated by the autonomous driving platform 200 that is not genuine. Accordingly, it is possible to improve vehicle control security.

### MODIFICATION EXAMPLES

Note that, in the present embodiment, the authentication information determination process is performed with respect to control instruction information received from the autonomous driving platform 200. In addition, in a case where the autonomous driving platform 200 is genuine, there is genuine authentication information added to the control instruction information. However, the genuine authentication information may not be added to the control instruction information. In other words, the vehicle control interface 300 may receive the genuine authentication information separately from the control instruction information, from the genuine autonomous driving platform 200.

For example, the vehicle control interface 300 may receive genuine authentication information from the genuine autonomous driving platform 200 each time a predetermined period of time elapses. Here, examples of the predetermined period of time include five minutes, one day, and one month. With the vehicle control interface 300 receiving genuine authentication information from the genuine autonomous driving platform 200 each time the predetermined period of times elapses, it is possible to determine that the autonomous driving platform 200 is genuine. In this case, the vehicle control interface 300 transmits, to the vehicle platform 100, the control instruction information received from the autonomous driving platform 200.

Meanwhile, in a case where the autonomous driving platform 200 is not genuine, the vehicle control interface 300 receives no authentication information from the autonomous driving platform 200 each time the predetermined period of time elapses. In addition, in a case where the autonomous driving platform 200 is not genuine, even if authentication information is received from the autonomous driving platform 200 each time the predetermined period of time elapses, the authentication information is not genuine authentication information. With regard to this, when the vehicle control interface 300 receives no authentication information from the autonomous driving platform 200 each time the predetermined period of time elapses, the vehicle control interface 300 prohibits control instruction information received from the autonomous driving platform 200 from being transmitted to the vehicle platform 100. In addition, even if there is authentication information received from the autonomous driving platform 200 each time the predetermined period of time elapses, when the authentication information is not genuine authentication information, the vehicle control interface 300 prohibits control instruction information received from the autonomous driving platform 200 from being transmitted to the vehicle platform 100.

Since the vehicle control interface 300 receives genuine authentication information from the autonomous driving platform 200 each time the predetermined period of time elapses as described above, whether or not the autonomous driving platform 200 is genuine can be determined a plurality of times. In this case, it is possible to improve vehicle control security in comparison with a case where transmission of control instruction information to the vehicle platform 100 is permitted after the vehicle control interface 300 receives genuine authentication information from the autonomous driving platform 200 once. In addition, genuine authentication information received from the autonomous driving platform 200 that is genuine may not be the same every time. For example, the genuine authentication information may be changed corresponding to a time at which the genuine authentication information is received or the position of the vehicle at the time of reception of the genuine authentication information.

In addition, a configuration in which, when the autonomous driving platform 200 in the vehicle control system 1 is changed, determination on whether or not there is genuine authentication information received from the autonomous driving platform 200 after the change is performed in the vehicle control interface 300 may also be adopted. In this case, when the autonomous driving platform 200 after the change is genuine, the vehicle control interface 300 receives genuine authentication information from the autonomous driving platform 200. Meanwhile, when the autonomous driving platform 200 after the change is not genuine, the vehicle control interface 300 receives no genuine authentication information from the autonomous driving platform 200. Therefore, in such a case, the vehicle control interface 300 prohibits control instruction information received from the autonomous driving platform 200 after the change from being transmitted to the vehicle platform 100. Accordingly, the vehicle is prohibited from being autonomously driven by the autonomous driving platform 200 after the change.

In addition, a configuration in which determination on whether or not there is genuine authentication information received from the autonomous driving platform 200 is performed in the vehicle control interface 300 when the vehicle control system 1 is activated may also be adopted. In this case, when the autonomous driving platform 200 is genuine, the vehicle control interface 300 receives genuine authentication information from the autonomous driving platform 200 at the timing of activation of the vehicle control system 1. Meanwhile, when the autonomous driving platform 200 is not genuine, the vehicle control interface 300 receives no genuine authentication information from the autonomous driving platform 200. Therefore, in such a case, the vehicle control interface 300 prohibits control instruction information received from the autonomous driving platform 200 from being transmitted to the vehicle platform 100 after the vehicle control system 1 is activated. Accordingly, the vehicle is prohibited from being autonomously driven after the vehicle control system 1 is activated.

In the vehicle control system 1 described above, when the autonomous driving platform 200 is not genuine, the vehicle control interface 300 prohibits control instruction information received from the autonomous driving platform 200 from being transmitted to the vehicle platform 100 such that the vehicle is prohibited from being autonomously driven. However, a method of prohibiting the vehicle from being autonomously driven by the autonomous driving platform 200 that is not genuine is not limited to such a method. For example, information indicating that the autonomous driving platform 200 is not genuine may be transmitted to the vehicle platform 100 along with control instruction information received from the autonomous driving platform 200 when the vehicle control interface 300 receives no predetermined authentication information from the autonomous driving platform 200. In addition, traveling control of the vehicle based on control instruction information that is received from the autonomous driving platform 200 via the vehicle control interface 300 may be prohibited in a case where the information indicating that the autonomous driving platform 200 is not genuine is received by the vehicle platform 100. Even with such a process, it is possible to prohibit the vehicle from being autonomously driven by the autonomous driving platform 200 that is not genuine.

In addition, the vehicle control interface 300 may request the autonomous driving platform 200 to transmit authentication information. For example, CHAP authentication may be performed between the vehicle control interface 300 and the autonomous driving platform 200. A challenge code is transmitted from the vehicle control interface 300. Then, the autonomous driving platform 200 receiving the challenge code transmits a hash value based on the challenge code. The vehicle control interface 300 may determine, based on the hash value received from the autonomous driving platform 200, whether or not the authentication information is authentication information indicating that the autonomous driving platform 200 is genuine. In addition, the autonomous driving platform 200 may determine whether to transmit authentication information even when there is no request for transmission of the authentication information made by the vehicle control interface 300.

In addition, as described above, the vehicle control ECU 101 in the vehicle platform 100 can also perform traveling control of the vehicle by means of control instruction information generated due to an operation performed by the occupant of the vehicle. Accordingly, even in a case where control instruction information generated by the autonomous driving platform 200 is not received, traveling of the vehicle can be controlled by means of control instruction information generated due to an operation performed by the occupant. Accordingly, even in a case where the autonomous driving platform 200 is not genuine, the vehicle can be moved by means of control performed due to an operation performed by the occupant. Note that, the “second control instruction information” according to the aspect of the disclosure corresponds to “control instruction information generated due to an operation performed by the occupant of the vehicle” in the present embodiment.

The vehicle control system 1 as described above has a configuration in which traveling control of the vehicle can be performed by means of control instruction information generated by the autonomous driving platform 200 and also can be performed by means of control instruction information generated due to an operation performed by the occupant of the vehicle. However, the vehicle control system according to the aspect of the disclosure also can be applied to a configuration in which traveling control of the vehicle is performed exclusively by means of control instruction information generated by the autonomous driving platform 200. That is, the vehicle control system according to the aspect of the disclosure can also be applied to a vehicle control system of a vehicle that is solely for autonomous driving.

### Other Embodiment

The above-described embodiments are merely examples and the disclosure can be implemented with appropriate modifications without departing from the gist of the disclosure. In addition, the processes or means described in the disclosure can be freely combined with each other as long as there is no technical contradiction.

In addition, a process that has been described as a process performed by one device may be divided up and performed by a plurality of devices. Alternatively, a process that has been described as a process performed by different devices may be performed by one device. It is possible to flexibly change with what kind of hardware configuration (server configuration) each function is realized in a computer system.

The disclosure also can be realized when a computer program, in which the functions described in the above-described embodiments are mounted, is supplied to a computer and one or more processors of the computer reads and executes the program. Such a computer program may be provided to a computer via a non-transitory computer-readable storage medium that can be connected to a system bus of the computer and may be provided to the computer via a network. Examples of the non-transitory computer-readable storage medium include any type of disk such as a magnetic disk (floppy (registered trademark) disk, hard disk drive (HDD), or like) and an optical disk (CD-ROM, DVD disk, Blu-ray disk, or like), a read only memory (ROM), a random access memory (RAM), an EPROM, an EEPROM, a magnetic card, a flash memory, an optical card, and any type of medium suitable for storing electronic commands.

What is claimed is:

1. A vehicle control system comprising:
a vehicle platform including a first computer configured to perform traveling control of a vehicle; and
an autonomous driving platform including a second computer configured to perform autonomous driving control of the vehicle, wherein:
the second computer generates first control instruction information with respect to the vehicle platform;
the first computer performs the traveling control of the vehicle based on the first control instruction information;
the vehicle control system further includes a vehicle control interface configured to receive the first control instruction information from the autonomous driving platform and configured to transmit the first control instruction information to the vehicle platform; and
the vehicle control interface includes a controller configured to prohibit the second computer from performing the autonomous driving control of the vehicle in a case where predetermined authentication information indicating that the autonomous driving platform is genuine is not received from the autonomous driving platform.

2. The vehicle control system according to claim 1, wherein the controller prohibits the first control instruction information from being transmitted to the vehicle platform in a case where the predetermined authentication information indicating that the autonomous driving platform is genuine is not received from the autonomous driving platform.

3. The vehicle control system according to claim 2, wherein the controller receives authentication information from the autonomous driving platform each time a predetermined period of time elapses and prohibits the first control instruction information from being transmitted to the vehicle platform in a case where a determination is made that the authentication information is not the predetermined authentication information.

4. The vehicle control system according to claim 2, wherein the controller prohibits the first control instruction information from being transmitted to the vehicle platform in a case where the predetermined authentication information is not received from the autonomous driving platform while the vehicle is not moving or when the vehicle starts to move.

5. The vehicle control system according to claim 2, wherein the controller prohibits the first control instruction information from being transmitted to the vehicle platform in a case where the predetermined authentication information is not received from the autonomous driving platform when the vehicle control system is activated.

6. The vehicle control system according to claim 2, wherein the controller prohibits the first control instruction information from being transmitted to the vehicle platform in a case where the predetermined authentication information is not received from the autonomous driving platform when the autonomous driving platform is changed.

7. The vehicle control system according to claim 2, wherein the controller prohibits the first control instruction information from being transmitted to the vehicle platform in a case where there is no predetermined authentication information added to the first control instruction information that the vehicle control interface receives from the autonomous driving platform.

8. The vehicle control system according to claim 2, wherein the first computer performs the traveling control of the vehicle based on second control instruction information for control of the vehicle platform that is generated based on an operation performed by an occupant of the vehicle.

9. A vehicle control interface configured to connect a vehicle platform and an autonomous driving platform, the vehicle platform including a first computer configured to perform traveling control of a vehicle and the autonomous driving platform including a second computer configured to perform autonomous driving control of the vehicle, wherein:
the second computer generates first control instruction information with respect to the vehicle platform;
the first computer performs the traveling control of the vehicle based on the first control instruction information;
the vehicle control interface is an interface configured to receive the first control instruction information from the autonomous driving platform and configured to transmit the first control instruction information to the vehicle platform; and
the vehicle control interface includes a controller configured to prohibit the first control instruction information from being transmitted to the vehicle platform in a case where predetermined authentication information indicating that the autonomous driving platform is genuine is not received from the autonomous driving platform.
